(19) United States
(12) Patent Application Publication
(10) Pub. No.: US 2008/0201403 A1
(43) Pub. Date: Aug. 21, 2008

(54) Maintaning a View of a Cluster's Membership

(75) Inventors: Per Andersson, Montreal (CA); Maria Toeroe, Montreal (CA); Makan Pourzandi, Montreal (CA); Frederic Rossi, Montreal (CA); Andre Beliveau, Laval (CA)

Correspondence Address: ERICSSON CANADA INC.;PATENT DEPARTMENT, 8400 DECARIE BLVD., TOWN MOUNT ROYAL, QC, H4P 2N2, omitted

(73) Assignee: TELEFONAKTIEBOLAGET LM ERICSSON (PUBL), Stockholm (SE)

(21) Appl. No.: 11/576,235

(22) PCT Filed: Sep. 29, 2004
(86) PCT No.: PCT/IB2004/051914

§ 371 Date: Dec. 17, 2007

(51) Int. Cl. G06F 15/16

(52) U.S. Cl. 709/202; 709/205

(57) ABSTRACT

A method for maintaining a current view of a cluster's membership comprising the steps of maintaining a list of member nodes and updating the list when a modification thereto is noticed by a first node by receiving a first update message from the first node in a second node, thereafter, sending a second update message from the second node to a third node to propagate the modification and sending to the first node a first confirm message from the second or the third node. A node member of a cluster capable of maintaining a first list of neighboring nodes, maintaining a second list of neighboring nodes sharing a current view therewith and ensuring that the first list matches the second by exchanging messages with neighboring nodes, wherein each message comprises topology information. Upon confirmation that both lists match, the node being capable of sending a confirmation message toward neighboring nodes.

### TECHNICAL FIELD

The present invention relates to distributed systems known as clusters and, more particularly, defines a cluster membership protocol thus enabling cluster membership management.

### DESCRIPTION OF THE RELATED ART

Clustering is a well established concept, which is now used in a variety of applications. Cluster computers tend to replace super computers since they are cheaper to build, maintain and their performance is more scalable. Clusters further open new avenues to provide high availability services. However, clustering brings new challenges, especially when members of clusters join and leave dynamically.

Some attempts were made to manage cluster membership dynamically, but those attempts fell short in answering numerous problems. For instance, some solutions propose election of a master node in the cluster through which all management should be done. The election causes a large overhead when the elected master changes frequently, which is to be considered seriously in a dynamic cluster. Another technique rely on knowledge of neighboring nodes distributed throughout the cluster. A decision algorithm identical on each computer is then used to determine an expected cluster configuration, supposing that all nodes will come to the same result from the same information. This other technique still creates problems since nodes may not agree on the expected configuration since, for instance, the information is not distributed completely and instantaneously. Adding an election mechanism thereover to select the expected configuration creates an overhead similar to the one already described. Yet another technique supposes the use of nodes having dedicated hardware to handle the management of the cluster membership. While this reduces the number of messages necessary to manage the cluster's membership, it creates a problem of robustness by limiting greatly the possibilities of recovery following a failure of the dedicated hardware. Moreover, in a cluster managed from a dedicated hardware, nodes isolated from the dedicated hardware are simply unusable. It should also be mentioned that scalability is quite limited in the prior art solutions.

Lately, a new consortium (The Service Availability™ Forum or SAForum) has been formed to promote the creation of high availability network infrastructure products, systems and services. The SAForum develops and publishes high availability and management software interface specifications. However, the prior art solutions presented earlier are not optimized to meet the requirements of the SAForum's specifications.

As can be appreciated, there is a need to define a new cluster membership management mechanism, which is the object of the present invention.

### SUMMARY OF THE INVENTION

A first aspect of the present invention is directed to a method for maintaining a current view of a cluster's membership in a network comprising a plurality of nodes. The method comprises the steps of maintaining a list of member nodes of the cluster and updating the list in member nodes of the cluster when a modification thereto is noticed by a first node. The step of updating further comprises receiving a first update message from the first node in a second node of the network, thereafter, sending a second update message from the second node to at least a third node of the network to propagate the modification and sending to the first node a first confirm message from one of the second or the third node confirming the modification. In the method, the second node is a neighboring node of the first node and the third node is a neighboring node of the second node.

Optionally, the method may further comprise, before sending to the first node the first confirm message, a step of receiving by the second node a second confirm message from the third node confirming the modification. In such a case, the step of sending to the first node the first confirm message is performed from the second node.

Another option is for the step of sending the first confirm message to be performed by resending the first update message back to the first node to confirm the modification.

In yet another optional implementation, the step of updating the list when a modification thereto is noticed is performed upon reception by the first node of a third update message containing the modification. In such a case, the third update message is received from a fourth node before the step of receiving the first update message in the second node and the fourth node is a neighboring node of the first node. The method then further comprises a step of sending a third confirm message from the first node to the fourth node upon reception of the first confirm message.

A second aspect of the present invention is directed to a node member of a cluster in a network comprising a cluster membership management protocol module. The module is capable of maintaining a first list of neighboring nodes, maintaining a second list of neighboring nodes sharing a current view of the cluster's membership therewith and ensuring that the first list matches the second list by exchanging a plurality of messages with at least one node in the first list of neighboring nodes, wherein each of the plurality of the messages comprises topology information on the cluster's membership. Upon confirmation that the first list matches the second list, the module is further capable of sending a confirmation message to at least one neighboring node listed on either equivalent lists.

Optionally, the cluster membership management protocol module of the node is further capable of receiving a commit view message from a first node on the first list of neighboring nodes, setting the current view as a stable view and forwarding the commit view message to at least a second node in the first list of neighboring nodes. In such a case, the cluster membership management module may further be capable of forwarding the commit view message to the second node only if the second node is not on a third list of neighboring nodes sharing the stable view.

Another optional implementation suggests that the cluster membership management module is further capable of determining if the node is an initiator of the first message from the plurality of messages and, if so, marking the current view as a stable view and sending the confirmation message to commit the current view as a stable view message toward the at least one neighboring node listed on either equivalent lists.

### BRIEF DESCRIPTION OF THE DRAWINGS

A more complete understanding of the present invention may be had by reference to the following Detailed Description when taken in conjunction with the accompanying drawings wherein:

FIG. 1 is an exemplary network topology presenting multiple nodes forming a cluster in accordance with the teachings of the present invention;

FIG. 2 is a first exemplary JOIN message as defined by the cluster membership management protocol in accordance with the teachings of the present invention;

FIG. 3 is a second exemplary JOIN message as defined by the cluster membership management protocol in accordance with the teachings of the present invention;

FIG. 4 is a third exemplary JOIN message as defined by the cluster membership management protocol in accordance with the teachings of the present invention;

FIG. 5 an exemplary network topology presenting multiple nodes forming at least one distinct cluster in accordance with the teachings of the present invention;

FIG. 6 an exemplary INSTALL message as defined by the cluster membership management protocol in accordance with the teachings of the present invention;

FIG. 7 is an exemplary flow and nodal operation chart of a message reception algorithm as defined by the cluster membership management protocol in accordance with the teachings of the present invention;

FIGS. 8A, 8B and 8C referred to together as FIG. 8 are signal flow and nodal operation charts showing an exemplary application of the cluster membership management protocol in accordance with the teachings of the present invention;

FIG. 9 is an exemplary flow chart of an INSTALL algorithm as defined by the cluster membership management protocol in accordance with the teachings of the present invention;

FIG. 10 is an exemplary flow chart of a discovery algorithm as defined by the cluster membership management protocol in accordance with the teachings of the present invention;

FIG. 11 is an exemplary signal flow and nodal operation chart for the cluster membership management protocol in accordance with the teachings of the present invention; and

FIG. 12 is an exemplary modular representation of a cluster node in accordance with the teachings of the present invention.

### DETAILED DESCRIPTION OF THE PREFERRED EMBODIMENTS

The present invention aims at providing a cluster membership management protocol that is fitted for large clusters in a dynamic environment. A basic concept of the present invention is to represent the state of cluster's membership through a unique view having a unique view identifier (view_id or vid), an associated topology (list of members) and an owner of the view for that topology. The cluster membership management protocol then specifies various mechanisms to make sure that all nodes members of the cluster at a given moment in time share the same view. In the context of the present invention, a view is defined by three values, i.e. a vid, a topology and an owner. Any modification in any of topology or owner info triggers a new view that is typically identified by a new, incremented vid. This can be optimized by identifying the cases when this the increment is not essential for the clear understanding of the membership information. The following description already applies many of these optimizations. The main mechanisms of the present invention are a discovery procedure enabling each node to acquire and maintain knowledge of neighboring nodes, a join procedure enabling distribution/negotiation of membership information and an install procedure enabling commitment of a stable view in each member node of the cluster. In the context of the present invention, the smallest cluster is represented by a single node. The description also takes for granted that each node potentially member of a cluster managed in accordance with the teachings of the present invention have a unique identifier (e.g. node_id).

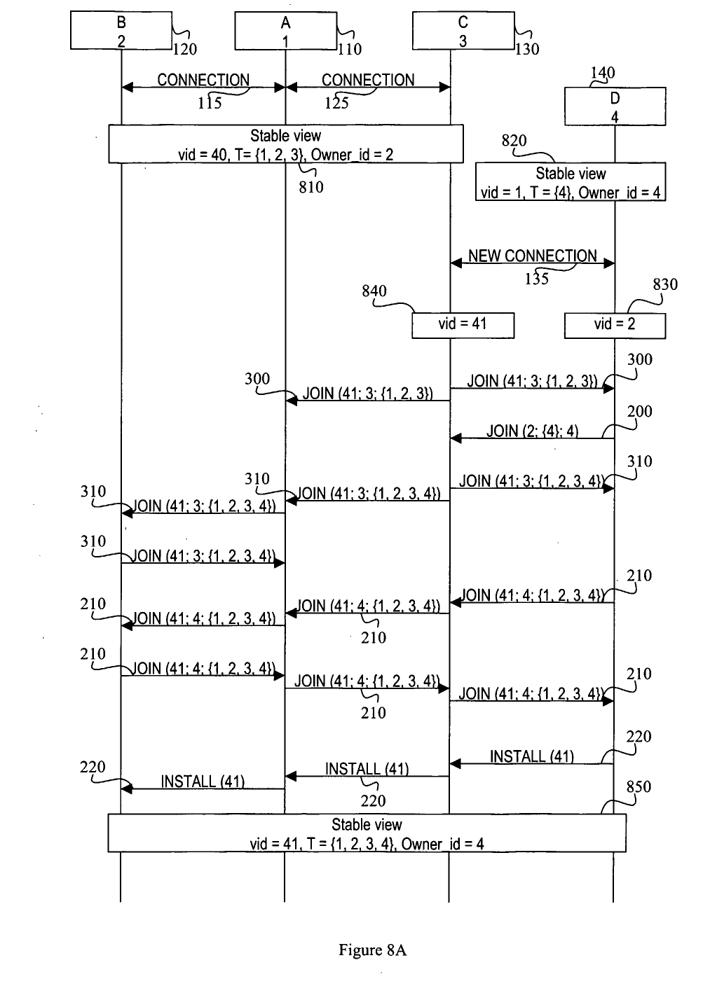

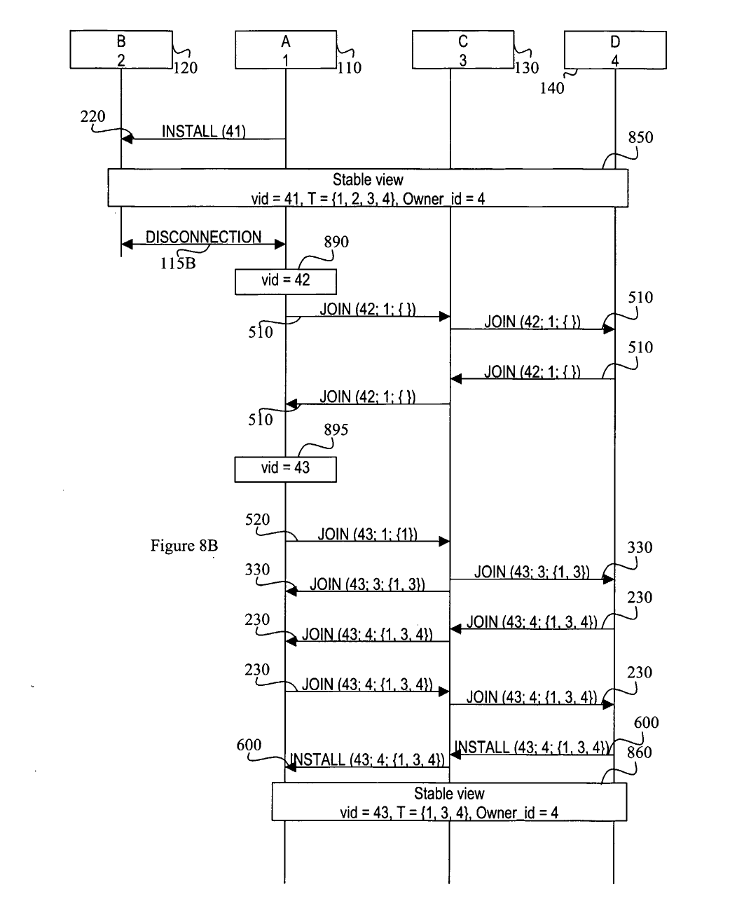

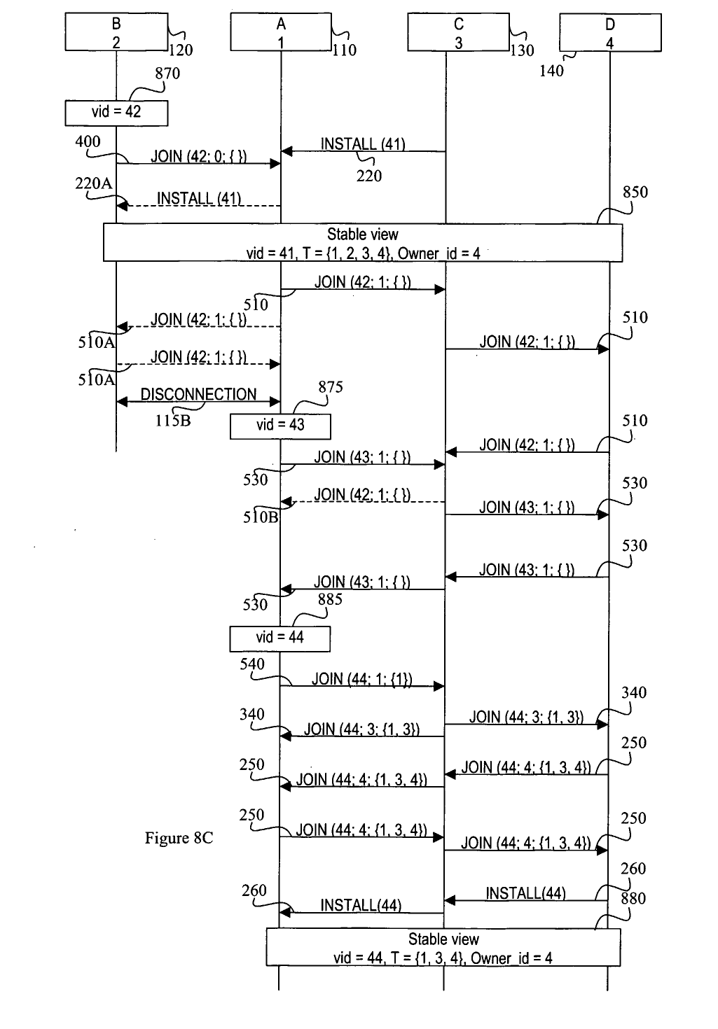

Reference is now made to the drawings wherein FIG. 1 shows an exemplary network topology 100 forming a simple cluster. FIG. 1 shows nodes A 110, B 120, C 130 and D 140 respectively having node_ids equal to 1, 2, 3 and 4. In the exemplary situation shown on FIG. 1, node A 110 is connected to node B 120 via a connection 115 and to node C 130 via a connection 125. The three nodes A 110, B 120 and C130 form a first cluster. At the beginning of the situation exemplified by FIG. 1, node D 140 is not connected to the other nodes. A connection 135 shown in doted lines on FIG. 1 is established later on as will be explained with concurrent reference to FIG. 1 and FIG. 8A, which shows a signal flow and nodal operation chart. It should be understood that connections 115, 125 and 135 are shown as single connections only for clarity purposes and could represent connections where intermediate nodes (e.g. routers, switch, hubs, etc.) are used in order to get the represented connection.

At the beginning of the present example, each node further maintains a stable view or state of the cluster's membership information. The stable view 810 maintained by nodes A 110, B 120 and C 130 is represented on FIG. 1 by a vid equal to 40 while the vid for the stable view 820 maintained by node D 140 is equal to 1. As shown on FIG. 8A, associated with the vid maintained in each node is a topology and an owner. In the case of nodes A 110, B 120 and C 130, the topology is equal to {1, 2, 3} and the node_id of the owner is, for instance, equal to 2 for the stable view 810. Each node also maintains a first list of all neighboring nodes (not shown) and a second list of all neighboring nodes sharing the same view (not shown; also called Nmap in the following discussion). In all case of stable views 810 and 820, the first list corresponds to the second. In the case of the stable view 820 maintained by node D 140, the topology is equal to {4} and the node_id of the owner is 4. In this exemplary situation, the owner is, from all the nodes that detected a new topology and initiated a new vid, the node having the highest node identifier. Since all nodes from each cluster are aware of this rule, all nodes tacitly agree on the owner of any stable view. Any other rule could be used as long as a unique owner could be determined. The owner, as will be shown later, has a role in the install procedure of the present invention.

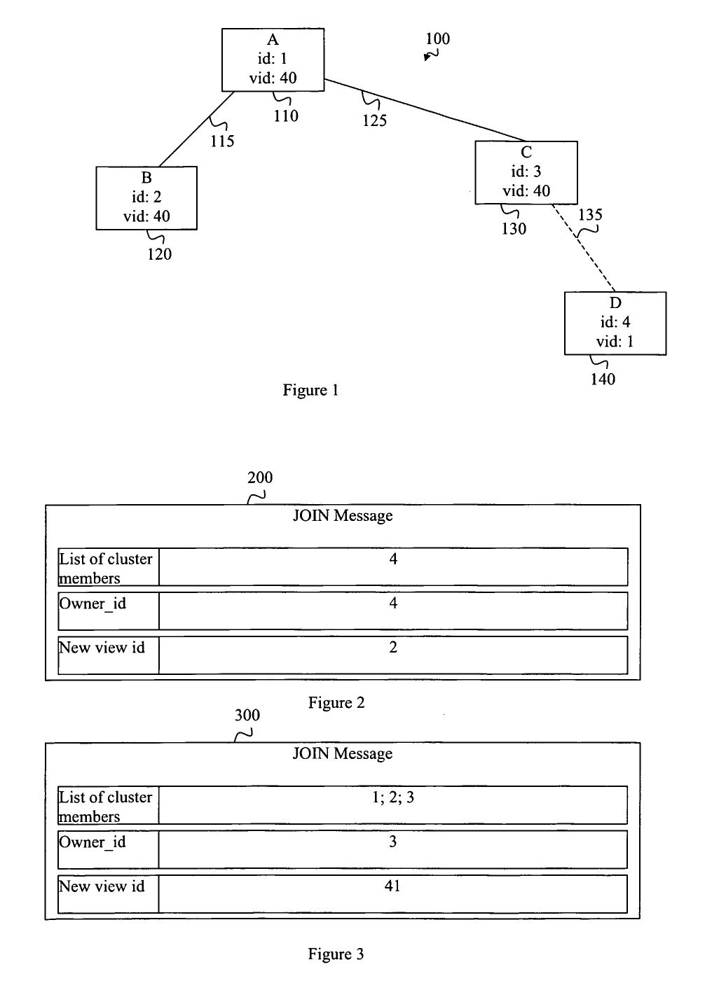

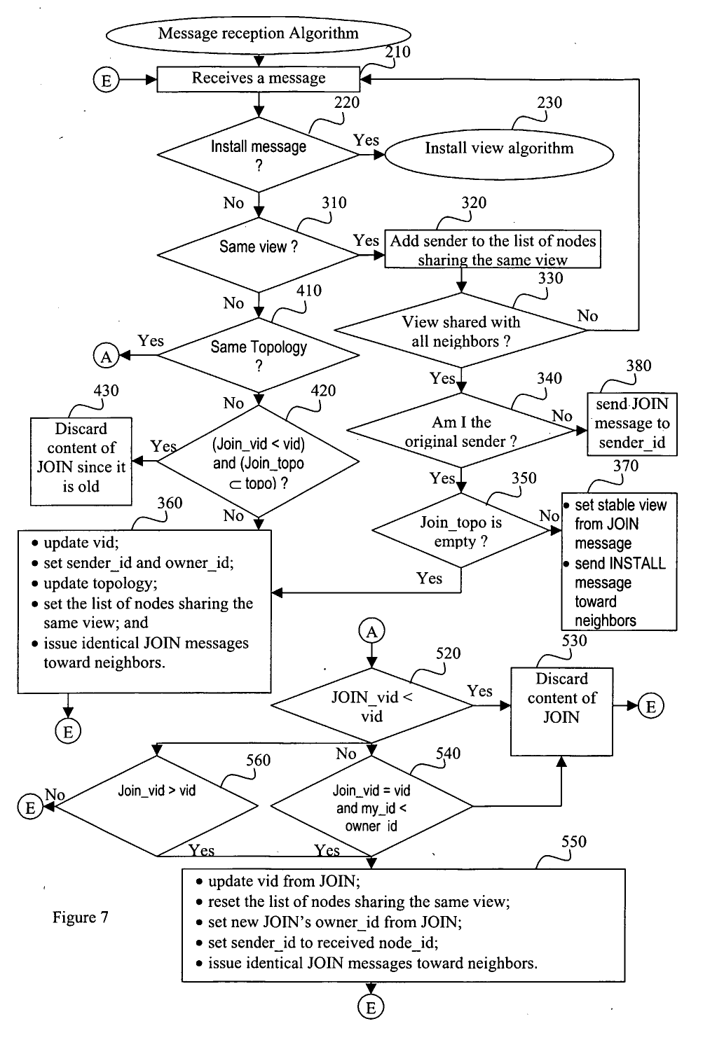

The following description is done from the perspective of node D 140. As will be shown later on with particular reference to FIG. 7, all nodes compatible with the cluster membership management protocol of the present invention apply the same algorithms. In the exemplary situation shown on FIG. 1 and FIG. 8A, upon establishment of the connection 135, node D 140 detects the neighboring node C 130. The detection itself can be performed in many ways and largely depends on the type of the connection 135 between D 140 and C 130. More details on the detection procedure will be given later on with other examples. Following the detection, D 140 notices that C 130 is not in the topology of the stable view it maintains and that a new view should be negotiated among the cluster's members. Reference is now concurrently made to FIG. 1, FIG. 8A and FIG. 2, which shows a first exemplary JOIN message 200 prepared by D 140 in the predefined context. More precisely, D 140 increments the vid of the stable view 820, that is now outdated, from 1 to 2 as shown by step 830 and places it in the JOIN message 200. Since D 140 detected the need for the new view, D 140 further puts itself as the owner of the new view by setting an owner_id of the JOIN message 200 to 4 and further places the topology of the cluster it represents in the JOIN message 200, which is limited to {4} in the present example. Node D 140 then sends the JOIN message 200 to all its neighbors (i.e. node C 130) and keeps a record of the fact that C 130 needs to acknowledge the JOIN message 200 by making sure that C 130 is not in the list of neighboring nodes sharing the same view. Acknowledging a JOIN message, in the context of the present invention, simply consist in replying with a JOIN message identical to the one received. Acknowledging is performed by a given node only when all messages sent by this given node has been acknowledged. Consequently, receiving an acknowledged JOIN message indicates that all nodes in the cluster that are connected downward with the sender of the acknowledging JOIN message share the same view. Any other way of acknowledging a JOIN message could be used without affecting the teachings of the present invention.

The following description is done from the perspective of node C 130. Node C 130 also detects a modification in its connection information since node D 140 is now connected thereto. Following the detection, C 130 notices that D 140 is to be added to the topology of the stable view 810 it maintains and that a new view should be negotiated among the cluster's members. Reference is now concurrently made to FIG. 1, FIG. 8A and FIG. 3, which shows a second exemplary JOIN message 300 prepared by C 130 in the predefined context. More precisely, C 130 increments the vid of the stable view 810, that is now outdated, from 40 to 41 as shown by step 840 and places it in the JOIN message 300. C 130 further puts itself as the owner of the new view by setting an owner_id of the JOIN message 300 to 3 and further places the topology of the cluster it represents in the JOIN message 300, which is {1, 2, 3} in the present example. Node C 130 then sends the JOIN message 300 to all its neighbors (i.e. nodes A 110 and D 140) and keeps track of the fact that nodes A 110 and D 140 need to acknowledge the JOIN message 300 by resetting the list of neighboring nodes sharing the same view. As shown on FIG. 8A, the order in which JOIN messages 200 and 300 are sent is not important. However, the exemplary situation illustrated suppose that the JOIN message 200 is sent before the JOIN message 300 is processed by D 140. Depending on the implementation, the processing of messages related to the present invention can be done upon reception, but may also be done sequentially by treating each message completely before processing the next buffered message. Therefore, the JOIN message 300 can be received or not at the time the JOIN message 200 is sent, but has not been processed since that would, in the present example, eliminate the need of the JOIN message 200, as will be better understood later with particular reference to FIG. 7.

Following reception of the JOIN message 200, C 130 compares the topology from the JOIN message 200 to the one it maintains. In the present case, the topology needs to be updated to add 4. Since the JOIN message 200 is not an acknowledgement of the JOIN message 300, C 130 updates its vid to the maximum value from its vid and the vid from the JOIN message 200, which is 41 in the present case. Since the topology changed (i.e. new view), C 130 further sets itself as the owner of vid 41 and reset the list of neighboring nodes sharing the same view. C 130 then sends a new JOIN message 310 to all its neighbors (A 110 and D 140) and keeps its own node_id (3) as the sender_id of the JOIN message 310. C 130 also keeps track of the fact that nodes A 110 and D 140 need to acknowledge the new JOIN message 310 rather than the JOIN message 300 by resetting the list of neighboring nodes sharing the same view. C 130 then waits for new messages.

C 130 then receives a further JOIN message 210 from D 140, which have vid=41, topology={1, 2, 3, 4} and owner_id=4. The only difference between the JOIN message 210 and the JOIN message 310 sent by C 130 is the owner_id, which is higher that the node_id of C 130. C 130 therefore updates this parameter, reset its list of neighboring nodes sharing the same view to include only node D 140 and forwards the further JOIN 210 to all its neighboring nodes that do not share the same view in accordance with the list previously updated (namely, A 110) and keeps track of the fact that node A 110 needs to acknowledge the JOIN message 210 rather than the JOIN message 310 by making sure A 110 is not on the list of neighboring nodes sharing the same view. C 130 further updates the sender_id of the JOIN message 210, which is 4 in the present example. When C 130 receives a new JOIN message, it checks if it is an acknowledgment (i.e. the JOIN message 210) from A 110 and if so, adds A 110 to the list of neighboring nodes sharing the same view. Node C 130 further verifies if the list of neighboring nodes sharing the same view corresponds to the list of neighboring nodes and if so, verifies if it was the originator of the JOIN message 210 or if the JOIN message 210 came from another source kept in the sender_id. Since, in the present example, the JOIN message 210 was issued by D 140, C 130 sends an acknowledgement (again, the JOIN message 210) thereto and wait for further messages. Since D 140 is the sender and originator of the JOIN message 210, subsequently C 130 receives an INSTALL message 220 therefrom specifying that the view described by the last JOIN message 210 is a stable view 850. C 130 then forward the INSTALL message 220 to all nodes, except its source (i.e. A 110).

The example of FIG. 8A continues on FIG. 8B since, at about the same moment that B 120 receives the INSTALL message 220, node B 120 also decides to leave the cluster as is shown by the disconnection 115B. The following example if taken with node A 110 as the node of reference. When A 110 detects the disconnection 115B, it notices that the topology of the stable view 850 needs to be updated to remove a node therefrom and A 110 therefore updates the vid from 41 to 42 as shown by step 890. In the present example, the approach is to reset the topology of the whole cluster and to rebuild it to make sure that B 120 is really disconnected from the cluster and not, for instance, disconnected from one node while still connected to another. Thus, A 110 sends a JOIN message 510 where the topology is empty or { }, the owner_id is 1 (for A 110) and the vid is 42 to all its neighboring nodes (i.e. C130) and takes note that C 130 needs to acknowledge the JOIN message 510 by making sure C130 is not on the list of node sharing the same view. Because A 110 is the only node that detected the disconnection 115B, it will receive an acknowledgment JOIN 510 from C 130. Upon reception of the JOIN message 510 from C 130, A 110 notices that all its neighboring nodes (i.e. C130) share the same view. A 110 therefore starts rebuilding the clusters's topology by updating vid from 42 to 43 (step 895) and sends a new JOIN message 520 where vid=43, owner_id=1 and topology={1}, since this represents the knowledge A 110 currently has of the cluster. A 110 then receives a JOIN message 330 where C 130 has added itself and, thus, taken ownership of the view (vid=43, owner_id=3 and topology={1, 3}). It will be assumed that A 110 does not have time to prepare a response to the JOIN message 330 before reception of another JOIN message 230 from C 130 in which the vid is still 43, but in which the owner_id is 4 and the topology is {1, 3, 4}. A 110 could however have acknowledge the JOIN message 330 toward C 130 (not shown). A 110, however, acknowledges the last JOIN message 230 since it has nothing to add thereto by resending it back to C 130, which in turn resends it to D 140.

The perspective is now changed to D140 after reception thereby of the JOIN message 230 from C 130. D 140 has to verify if the received JOIN message 230 relates to a known view (i.e. the JOIN message 230 already transited through D 140 and no new view has been initiated therebetween), which is the case in the present example. D 140 notes that C 130 has acknowledged the JOIN message 230 by adding it to its list of neighboring nodes sharing the same view. Since, in the present case, its list of neighboring nodes sharing the same view corresponds to the list of neighboring nodes maintained thereby, D 140 further verifies if it is the original issuer of the JOIN message 230 by comparing the sender_id kept upon sending the JOIN message 230 earlier and its own node_id. Since the sender_id and its own node_id are equal and because the topology of the JOIN message 230 is not empty, in the present example, D 140 sets a new stable view 860 with the parameters of the JOIN message 230. Reference is now made concurrently to FIG. 8B and FIG. 6, which shows an INSTALL message 600 prepared by D 140 in the predefined context. The INSTALL message 600 issued by D 140 triggers the installation of the new stable view 860 where vid=43, owner_id=4 and topology={1, 3, 4}. FIG. 8B shows the stable view 860 being installed after reception of the INSTALL message 600 by A 110. It should however be noted that the stable view 860 is installed sequentially by each node upon reception of the INSTALL message 600 and that FIG. 8B only shows the final state in which all nodes from the topology thereof have installed the stable view 860 for clarity purposes. As noted, the INSTALL message 600 contains the same view (i.e. vid=43, owner_id=4 and topology={1, 3, 4}) than the last JOIN message 230. In some other implementations, the INSTALL message 600 could simply comprise the vid since the receiving nodes are already aware of the other view information, as shown by the INSTALL message 220 previously shown on FIG. 8A. This alternative could however present some risks when two pre-existing clusters merge together and is therefore not adopted elsewhere in the presented examples.

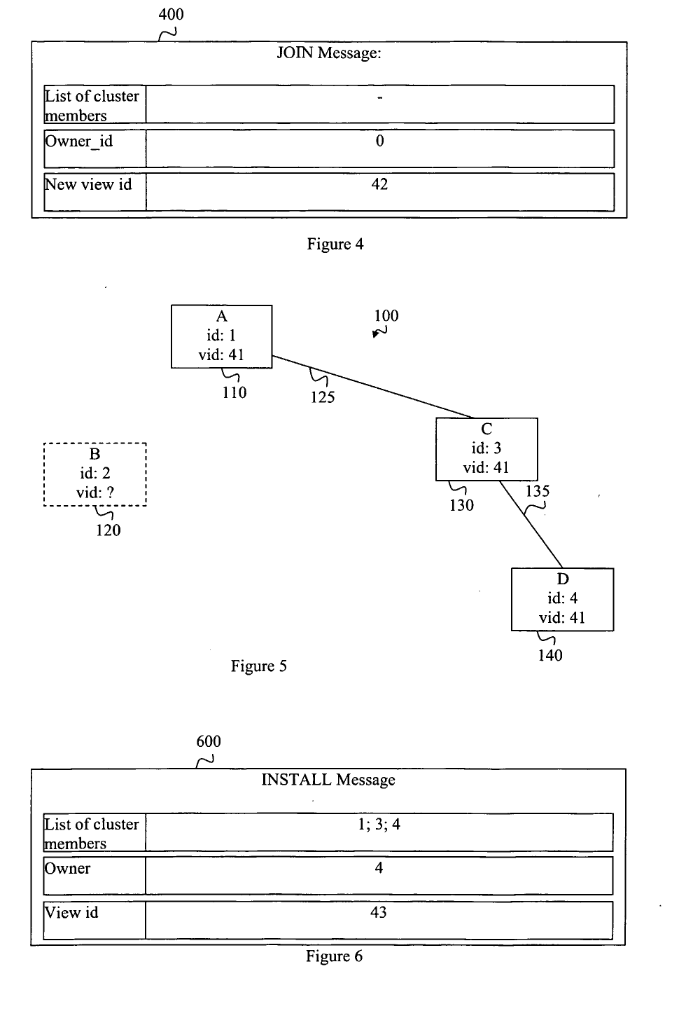

Alternatively, the example of FIG. 8A also continues on FIG. 8C with a different approach, since before disconnecting from the cluster, B 120 graceful informs the cluster of the disconnection to come. Reference is now concurrently made to FIG. 1, FIG. 8C and FIG. 4, which shows an exemplary JOIN message 400 prepared by B 120 in the predefined context. More precisely, B 120 increments the vid of the last known view from the JOIN message 210, that is now outdated, from 41 to 42 as shown by step 860, places an empty topology ({ }) and puts an invalid node_id (e.g. 0) as the owner_id of the JOIN message 400 before sending it to all its neighboring nodes (i.e. A 110). Sending an empty topology triggers a graceful termination since B 120 notifies the cluster, via the JOIN message 400, of the upcoming disconnection 115B. In this context, B 120 may or not be aware of the stable view 850 being installed by the INSTALL message 220 shown on FIG. 8A, as shown by the possibility of the INSTALL message 220A being received or not after issuing the JOIN message 400.

The following example if taken with node A 110 as the node of reference. Upon reception of the JOIN message 400, A 110 issues a JOIN message 510 in which it has taken ownership of the view. Note that the JOIN message 510 is also used in the example shown on FIG. 8B. However, depending on the implementation, A 110 may or may not send a JOIN message 510A to B 120 since this node is disconnecting. One reason for sending it would be to inform B 120 of the result of its JOIN message 400. The reply of B 120 to the JOIN 510A is also optional and is not needed by A 110 before going forward in the algorithms of the present invention. In the present example, A 110 detects the disconnection 115B before reception of an acknowledging JOIN message 510B from C 130. A 110 thus updates the vid from 42 to 43 (step 875), resets its list of neighboring nodes sharing the same view and issues a new JOIN message 530 toward all its neighboring nodes not sharing the same view (i.e. C 130). In another implementation, if A 110 had received the JOIN message 510B from C 130 or not, detection of the disconnection 115B could have been ignored and seen as a confirmation of the graceful termination triggered by the JOIN message 400. However, FIG. 8C shows the example where A 110 issues the JOIN message 530 and waits for the acknowledging JOIN message 530 from C130. Upon reception thereof, A 110 notices that all its neighboring nodes (i.e. C130) share the same view. A 110 therefore starts rebuilding the clusters's topology by updating vid from 43 to 44 (step 885) and sends a new JOIN message 540 where vid=44, owner_id=1 and topology={1}, since this represents the knowledge A 110 currently has of the cluster. A 110 then receives a JOIN message 340 where C 130 has added itself and, thus, taken ownership of the view (vid=44, owner_id=3 and topology={1, 3}). It will be assumed that A 110 does not have time to prepare a response to the JOIN message 340 before reception of another JOIN message 250 from C 130 in which the vid is still 44, but in which the owner_id is 4 and the topology is {1, 3, 4}. A 110 could however have acknowledge the JOIN message 340 toward C 130 (not shown). A 110, however, acknowledges the last JOIN message 250 since it has nothing to add thereto by resending it back to C 130, which in turn resends it to D 140. Similarly to the example shown on FIG. 8B, a stable view 880 (vid=44, owner_id=4 and topology={1, 3, 4}) is installed by D 140 through an INSTALL message 260.

Reference is now made concurrently to FIG. 8 and FIG. 5, which shows a topology of the network 100 following completion of the example of either FIG. 8B or FIG. 8C by which B 120 disconnected from the cluster previously shown on FIG. 1. None of the node sharing the stable view 860 or 880 now has knowledge of the presence and state of B 120. This is represented on FIG. 5 by placing B 120 in dashed line and placing a question mark in lieu of the vid maintained thereby.

The following is a generalization of the example previously described. It is still an exemplary implementation and should be regarded as such. Multiple optimizations are included in the following algorithms and are not to be regarded as the core of the invention. In the tables below, Q is the node from which the algorithms are executed. Vq is the vid of the current view Q negotiated in the cluster. IDc is the node_id of the owner of the current view negotiated in the cluster and Tc is the topology of the cluster currently negotiated. Vc, IDc and Tc are related to the last stable view of the cluster maintained by Q. LN is a list of neighboring nodes and Nmap is a list of all neighboring nodes sharing the same view (Vq, IDq, Tq). The algorithms are written using pseudo-code logic and structure as is well known in the art.

Upon power-up or upon first initialization of the cluster's membership management protocol of a node compatible therewith, the following Initialization algorithm is executed.

TABLE 1
Initialization algorithm

Initialization:

| | |
|---|---|
| 1 | (Vq, IDq, Tq) = (0, Q, {Q}) // at boot time |
| 2 | (Vc, IDc, Tc) = (Vq, IDq, Tq) |
| 3 | INSTALL (Vc, IDc, Tc) // cluster of one node − Q |
| 4 | LN = { } |
| 5 | Continue with Discovery signalling and Join phase simultaneously |

The result of the preceding is a cluster of 1 node (Q) having a vid of 0, a topology equal to {Q} and owned by Q.

Following execution of Initialization, the Discovery signalling algorithm is executed simultaneously with the Join phase algorithm, as mentioned on line 5. Both algorithms combined with the Install algorithm, invoked from the JOIN phase algorithm, enable exchanging messages for ensuring that the list of neighboring nodes (LN) matches with the list of neighboring nodes sharing the same view (Nmap). In other words, a stable view is the final result of the following algorithms.

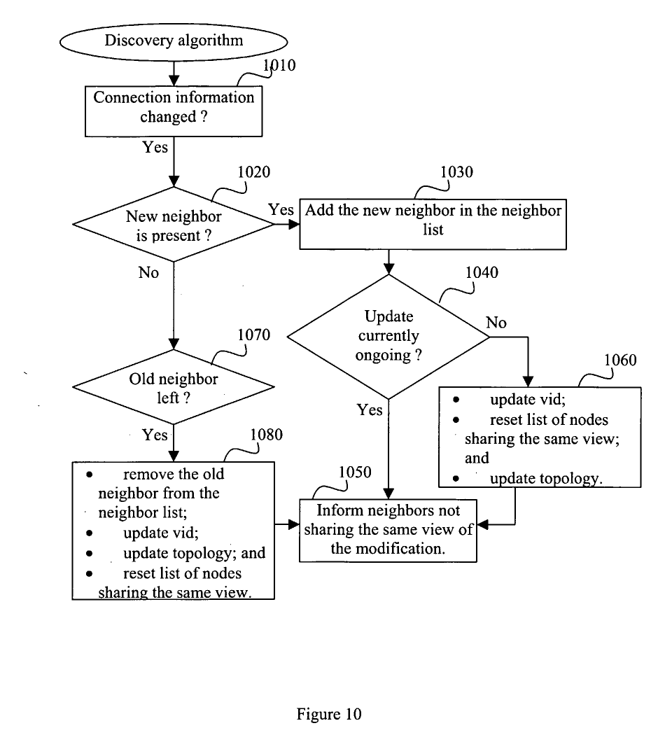

FIG. 10 is an exemplary flow chart of a discovery algorithm as defined by the cluster membership management protocol in accordance with the teachings of the present invention.

TABLE 2
Discovery phase algorithm.

Discovery signalling:

| | |
|---|---|
| 1 | while (change in connection info) do |
| 2 | begin |
| 3 | if a new neighbor N has been discovered then |
| 4 | begin |
| 5 | LN = LN U {N} |
| 6 | if Vq == Vc OR conf then |
| 7 | begin |
| 8 | (Vq, IDq, Tq) = (Vc+1, Q, Tq) |
| 9 | Nmap = { } |
| 10 | conf = FALSE |
| 11 | Sender_ID = Q |
| 12 | send JOIN (Vq, IDq, Tq) to all in LN \ Nmap |
| | (including N) |
| 13 | end |
| 14 | else |
| 15 | begin |
| 16 | send JOIN (Vq, IDq, Tq) to N |
| 17 | end |
| 18 | end |
| 19 | if an existing neighbor M has been lost then |
| 20 | begin |
| 21 | LN = LN \ {M} |
| 22 | (Vq, IDq, Tq) = (Vc+1, ID=Q, { }) // initiating a reset of |
| | membership information |
| 23 | Nmap = { } |
| 24 | conf = FALSE |
| 25 | Sender_ID = Q |
| 26 | send JOIN (Vq, IDq, Tq) to all neighbors |
| 27 | end |
| 28 | end //discovery signalling |

The Discovery algorithm start at step 1010 shown on FIG. 10, which is equivalent to line 1 of the preceding table (Table 2: Discovery phase algorithm), when Q detects a modification in the connection information. As mentioned previously, the detection method of step 1010 varies depending on the physical link by which Q is connected to its neighboring nodes and falls outside the scope of the present invention. Following the detection 1010, Q tests if a new neighboring node N is present (step 1020, line 3).

If so, Q adds the new neighboring node N to its list of neighboring nodes (step 1030, line 5). Following the addition of N to the list of neighboring nodes, Q verifies if the cluster is currently negotiating a new view (step 1040). This is done by comparing the current view vid and the stable view vid (line 6). If they are not equal (Vc< >Vq), it means that the cluster is currently renegotiating a new stable view and that Q needs to include N in the process since it does not share the same view (step 1050, line 16). If they are equal (Vc=Vq), a new negotiation initiated by Q needs to take place (step 1060, lines 8-12). Q therefore updates the current vid and takes ownership of the new negotiation (line 8), resets the list of neighboring nodes sharing the same view (Nmap) (line 9) and puts itself as the initiator of the new negotiation (line 11). Q then sends the information related to the new negotiation it started to all its neighboring nodes not sharing the same view (in this case, all nodes) (step 1050, line 12).

If it is determined from step 1070 (line 19) that the detection of step 1010 related to an existing neighboring node M leaving the neighborhood of Q, then M is removed from the list of neighboring nodes (line 21), Q takes ownership of the new negotiation, updates the vid and resets the topology (line 22). Q further resets the list of neighboring nodes sharing the same view (Nmap) (line 23) and puts itself as the initiator of the new negotiation (line 25). Lines 22-25 are presented on FIG. 10 in step 1080. Q then sends the information related to the new negotiation it started to all its neighboring nodes not sharing the same view (in this case, all nodes) (step 1050, line 26).

The number of messages exchanged for monitoring changes to connection information toward neighboring nodes and for the negotiation of the cluster membership polynomially increases with the number of neighboring nodes. Some optimization could be applied to reduce the number of messages due to the increasing number of nodes within a given cluster. The optimized algorithm shall however guaranty that, at any given moment, every potential cluster member node will have at least one neighboring node within the cluster. On FIG. 10, the step 1030 could implement such an optimization.

FIG. 7 is an exemplary flow chart of a message reception algorithm as defined by the cluster membership management protocol in accordance with the teachings of the present invention. The message reception algorithm starts with the reception of a new message (step 210) from a neighboring node R. If the received message is an INSTALL message, the INSTALL phase algorithm is invoked (step 230) (INSTALL phase shown following the JOlNphase algorithm in the description). If the received message is a JOIN message, the JOIN phase algorithm starts by comparing the view received from R (Vr, IDr, Tr) with the one it maintains (Vq, IDq, Tq) (step 310, line 3). If they are the same, the description continues after the following table (Table 3: JOIN phase algorithm; part 1) otherwise, the description continues after the Table 4: JOIN phase algorithm; part 2.

TABLE 3
JOIN phase algorithm; part 1.

Join phase:

| | |
|---|---|
| 1 | while ( JOIN-VIEW received ) do // Receive JOIN (Vr, IDr, Tr) from R, R is in |
| | LN |
| 2 | begin |
| 3 | if (Vr, IDr, Tr) == (Vq, IDq, Tq) then |
| 4 | begin |
| 5 | Nmap = Nmap U {R} // R confirmed that it has the same view |
| 6 | if conf AND Nmap == LN then |
| 7 | begin |
| 8 | conf = TRUE // to avoid sending further confirmations |
| 9 | if Sender_ID == Q then // Q initiated / owns the view to be installed |
| 10 | if Tr == { } then // reset procedure |
| 11 | begin // reset is finished, start new join procedure |
| 12 | Nmap = { } |
| 13 | conf = FALSE |
| 14 | (Vq, IDq, Tq) = (Vq+1, Q, {Q}) // or with {Q} U LN |
| 15 | send JOIN (Vq, IDq, Tq) to all in LN |
| 16 | end |
| 17 | else |
| 18 | begin // join is confirmed, start to install view |
| 19 | (Vc, IDc, Tc) = (Vq, IDq, Tq) |
| 20 | send INSTALL (Vc, IDc, Tc) to all in LN |
| 21 | end |
| 22 | else // confirm that all “children” have the same view |
| 23 | send JOIN (Vq, IDq, Tq) to node Sender_ID |
| 24 | end |
| 25 | else |
| 26 | break |
| 27 | end |

Join phase (interrupted) ...

The JOIN phase algorithm is interrupted here, on line 27, for clarity purposes, but continues on line 28 below. The JOIN phase algorithm starts by comparing the view received from R (Vr, IDr, Tr) with the one it maintains (Vq, IDq, Tq) (step 310, line 3). If the views are equal (i.e. Vr=Vq, IDr=IDq and Tr=Tq), then Q adds R to its list of neighboring nodes sharing the same view (Nmap) (step 320, line 5).

If Nmap corresponds to LN, or in other words if the list of neighboring nodes sharing the same view corresponds to the list of neighboring nodes, Q verifies if it is the initiator or the original sender of the message received from R (step 330, line 9) by comparing the sender_id value it keeps with its node_id. The sender_id value is the node_id of the sender the original sender of a JOIN message from the perspective of the receiver (not from a cluster's perspective) and is kept before creating or forwarding a JOIN message. Therefore, if the sender_id kept by Q for the received JOIN message is Q, it means that Q initiated the received JOIN message, which is an acknowledging JOIN message, as described previously.

If the topology of the received JOIN message (Tr) is empty ({ }) (step 350, line 10), Q received an acknowledging JOIN message for a reset procedure, which is now finished. A new JOIN procedure should be started (step 360, lines 12-15), which corresponds to reset of the list of nodes sharing the same view, update vid (Vq), set sender_id (kept locally) and owner_id (included in the JOIN to be sent) to my_id (i.e. Q), update the topology (Tq) and issue identical JOIN messages toward neighbors (listed in LN). The update of the topology, in the new JOIN procedure following a reset can be set to only myid {Q} or could also be set to {Q} U LN (myid and all neighboring nodes). However, it should be noted that the second possibility assumes that all neighboring nodes listed in LN are compatible with the cluster membership management protocol of the present invention.

If the verification of step 350, line 10 shows that the topology Tr of the received JOIN message (Tr) is not empty, Q needs to install a new stable view and does so by setting Vc, IDc and Tc respectively to Vq, IDq and Tq and by sending an INSTALL message corresponding thereto to all its neighboring nodes (LN, but Nmap would obviously do the same) (step 370, lines 18-19).

If the verification of step 340, line 9 shows that the sender_id associated to the received JOIN message is not Q, then Q acknowledges the received JOIN message to the sender_id (step 380, line 23). The break of line 26, as all other breaks shown in the related tables, returns the control flow to the first line of the algorithm where the nest message is expected.

If the view from the JOIN message received from R (Vr, IDr, Tr) is not equal to (Vq, IDq, Tq) (step 310, line 3), the description continues after the following table (Table 4: JOIN phase algorithm; part 2).

TABLE 4
JOIN phase algorithm; part 2.

... Join phase (continued)

| | |
|---|---|
| 28 | else // different views |
| 29 | begin |
| 30 | if Tr == { } OR (Tq == { } AND Nmap!= LN) then // it's reset mode |
| 31 | begin |
| 32 | if Tr != { } then // local is in reset mode, remote is not |
| 33 | if Vr >= Vq then // need a higher view # for the reset to complete |
| 34 | begin |
| 35 | (Vq, IDq, Tq) = (Vr+1, Q, { }) |
| 36 | Sender_ID = Q |
| 37 | Nmap = { } |
| 38 | conf = FALSE |
| 39 | send JOIN (Vq, IDq, Tq) to all in LN |
| 40 | end |
| 41 | break // delete everything else, reset has been sent |
| 42 | if Tq == { } then // local and remote are in reset mode |
| 43 | if Vr > Vq OR (Vr == Vq AND IDr > IDq) then // if it's a new reset |
| 44 | begin |
| 45 | (Vq, IDq, Tq) = (Vr, IDr, Tr) |
| 46 | Sender_ID = R |
| 47 | Nmap = {R} |
| 48 | conf = FALSE |
| 49 | send JOIN (Vq, IDq, Tq) to LN \ {R} |
| 50 | end |
| 51 | break |
| 52 | else // local may need to be reset |
| 53 | begin |
| 54 | if Vr < Vq then break // old reset, drop it |
| 55 | if Vr > Vq then // received reset acceptable |
| 56 | begin |
| 57 | if IDr == 0 then // the sender is leaving therefore cannot be the |
| | owner |
| 58 | begin |
| 59 | Sender_ID = Q |
| 60 | (Vq, IDq, Tq) = (Vr, Q, Tr) // take ownership |
| 61 | LN = LN \ {R} // remove sender from the neighbor list |
| 62 | Nmap = { } |
| 63 | end |
| 64 | else |
| 65 | begin |
| 66 | (Vq, IDq, Tq) = (Vr, IDr, Tr) |
| 67 | Sender_ID = R |
| 68 | Nmap = {R} |
| 69 | end |
| 70 | conf = FALSE |
| 71 | send JOIN (Vq, IDq, Tq) to LN \ Nmap |
| 72 | end |
| 73 | else // view # conflicts, needs to be incremented |
| 74 | begin |
| 75 | Nmap = { } |
| 76 | conf = FALSE |
| 77 | Sender_ID = Q |
| 78 | (Vq, IDq, Tq) = (Vq+1, Q, { }) |
| 79 | send JOIN (Vq, IDq, Tq) to LN |
| 80 | end |
| 81 | end |
| 82 | break // drop everything else (Nmap is full) |
| 83 | end // end reset mode |

Join phase (interrupted) ...

The JOIN phase algorithm is interrupted here, on line 83, for clarity purposes, but continues on line 84 below. If, at step 310 line 3, Q verified that the view it maintains (Vq, IDq, Tq) is not equal to the received one (Vr, IDr, Tr), Q then verifies if the cluster is in a reset mode (not shown on FIG. 7). This is done by verifying that Tr is equal to { } or that Tq is equal to { } and Nmap is different than LN. In other words, Q verifies that either the received topology is empty or that the current topology is empty and the list of neighboring nodes sharing the same view does not correspond to the list of neighboring nodes. The first condition would indicate a reset ongoing or starting while the second would indicate a reset on going with R not being aware of it.

Q then further differentiates between the two possibilities by verifying on line 32 if Tr is not empty. If Tr is not empty, Q verifies if the received vid Vr is greater or equal to the vid it maintains Vc (line 33). If such is the case, this indicates that Vr needs to be updated in order for the reset procedure to complete. Q thus keeps itself as sender_id, reset the list of neighboring nodes sharing the same view (Nmap). It then updates vid by incrementing Vr, putting an empty topology and itself as the owner and sends the thereby built JOIN message to all its neighboring nodes (lines 35-39). The loop is then broken (line 41) since a reset has been sent (previously or through lines 35-39).

If the current topology is empty (line 42; meaning that Tr is empty because of 32 and 41), Q and R are in a reset procedure. Line 43 then verifies if Vr is greater than Vc or if Vr equals Vc and IDr is greater than IDc. If so, then the received JOIN message establishes a new reset procedure (different vid or same vid with different owner_id). Q therefore puts its view (Vc, IDc, Tc) in conformity with the received one (Vr, IDr, Tr), keeps R as sender_id, puts R on the list of neighboring nodes sharing the same view (Nmap={R}) and forwards the received JOIN message (or the equivalent) to all its neighboring nodes not on the list of neighboring nodes sharing the same view (lines 45-49). The loop is then broken (line 51) since the new reset procedure detected on line 43 has been treated.

If the current topology is not empty (line 52), Q may need to be put in reset and therefore checks if Vr is smaller than Vq. If so, then the received message is an old one and should be discarded (line 54). If Vr is greater or equal to Vq, then the received reset is acceptable and needs to be treated (line 55). Thereafter, Q verifies if IDr is equal to 0 (line 57). The only situation where that can happen is in the case of graceful termination, as will be understood better later with reference to the graceful termination algorithm. In such a case, Q takes ownership of the JOIN message, resets Nmap, keeps my_id as sender_id and removes the sender (R) from the list of neighboring nodes (lines 59-62). If the verification of line 57 shows that IDr is not 0, then R is added to the list of neighboring nodes sharing the same view, sender_id is set to R and the current view is set in accordance with the received view (lines 66-68). In all cases of acceptable reset (line 55), the current view is further sent in a JOIN message to the list of neighboring nodes except the nodes on the list of neighboring nodes sharing the same view (LN\Nmap) (line 71). In a version of the algorithm that would not contain all optimizations, the JOIN message could be sent to all neighboring nodes except R without impacting the functioning of the algorithm, but that would significantly increase the network traffic related thereto.

If the verification of line 55 shows that Vr is not greater than Vq and because of line 54, the only possible conclusion is that Vq=Vr, which should not happen since the views are different (line 28). In such a case, the vid is incremented, Q takes ownership of the view, puts itself as sender_id and sends a new JOIN to all its neighboring nodes (lines 75-79). All relevant cases related to the reset procedure detected in line 30 being treated, the loop thereafter breaks.

The next table (Table 5: JOIN phase algorithm; part 3) shows the situation where a JOIN message is received with a different view outside the possibility of a reset.

TABLE 5
JOIN phase algorithm; part 3.

... Join phase (continued)

| | |
|---|---|
| 84 | if Tq != Tr then // lists are not equal |
| 85 | begin |
| 86 | if conf AND Tq == { } then // first join after reset |
| 87 | if Vr <= Vq then // a node may have been reset, if it requires any action |
| | take care of it here |
| 88 | Tq = {Q} // reinitialize the member list, {Q} U LN |
| 89 | if Tr < Tq then // remote is a subset of the local |
| 90 | if Vr <= Vq then |
| 91 | if Vr == 1 then // initial view number + 1 may mean node reset, start |
| | a new view |
| 92 | begin |
| 93 | (Vq, IDq, Tq) = (Vq +1, Q, Tq) |
| 94 | Sender_ID = Q |
| 95 | Nmap = { } |
| 96 | send JOIN (Vq, IDq, Tq) to all in LN |
| 97 | end // otherwise drop it |
| 98 | break // this is an old message |
| 99 | else // view # needs to be increased |
| 100 | begin |
| 101 | (Vq, IDq, Tq) = (Vr, Q, Tq) |
| 102 | Sender_ID = Q |
| 103 | Nmap = { } |
| 104 | send JOIN (Vq, IDq, Tq) to all in LN |
| 105 | end |
| 106 | else // remote isn't a subset |
| 107 | begin |
| 108 | if intersection (Tr, Tq) != { } AND Vr < Vq then // Vr < Vq only in |
| | split brain |
| 109 | break // old message |
| 110 | conf = FALSE |
| 111 | if Tq < Tr then // local list is a subset |
| 112 | begin |
| 113 | (Vq, IDq, Tq) = (Vr, R, Tr) |
| 114 | Sender_ID = R |
| 115 | Nmap = {R} |
| 116 | end |
| 117 | else |
| 118 | begin |
| 119 | (Vq, IDq, Tq) = (max (Vq, Vr), Q, Tq U Tr) |
| 120 | Sender_ID = Q |
| 121 | Nmap = { } |
| 122 | end |
| 123 | if Nmap == LN then // Nmap is full − one neighbor |
| 124 | begin |
| 125 | conf = TRUE |
| 126 | send JOIN (Vq, IDq, Tq) to all neighbors in LN |
| 127 | end |
| 128 | else |
| 129 | send JOIN (Vq, IDq, Tq) to all neighbors in LN \ Nmap |
| 130 | end |
| 131 | end |

Join phase (interrupted) ...

The JOIN phase algorithm is interrupted here, on line 131, for clarity purposes, but continues on line 132 below. If the views are different ((line 28), but it is not a reset procedure (line 30), the next possible difference tested in step 410 (FIG. 7) line 84 is a difference in the received topology (Tr) and the current topology Tq that Q maintains (step 410, line 84). Then, Q verifies if the current topology Tc is empty, which is the case for the first received message after the reset procedure (line 86) in such a case, if Vr is less or equal to Vq, then the current topology is reset to Q only (line 87) and the algorithm continues (as will be shown later on, a JOIN message will be sent as Tq is now a subset of Tr).

Line 89 and 90 corresponds to step 420 where it is determined if Vr is less or equal to Vq and Tr is included in Tq. If it is the case, then the received topology Tr is a subset of the current topology Tq with a vid smaller (thus from an older view) than the current vid. Therefore, the message can be discarded as shown by the break of line 98 or step 430. However, before breaking, Q verifies if Vr is equal to 1 (line 91, not shown), which is the case after restart of the node or of its algorithm. To enable this node to obtain the cluster's information, Q initiates a new JOIN procedure by incrementing Vq, taking ownership of the new JOIN, keeping Q as sender_id (i.e. my_id or itself), resetting Nmap and sending the new JOIN to all nodes on the list of neighboring nodes (lines 93-96).

If, on step 420 (line 89-90) it is determined that the current vid Vq is less or equal to the received vid Vr (line 99), then it means that the current vid Vq needs to be updated to the received vid Vr. Since the received topology Tr is a subset of the current topology Tq (as of line 89), the current view (Vq, IDq, Tq) is updated to (Vr, Q, Tq). In details, this is achieved by setting Vq to Vr, IDq (owner) to Q, the topology remaining unchanged. Sender_id is further set to Q, Nmap is reset and the JOIN message is sent to nodes on the list of neighboring nodes (LN) (lines 101-104).

If it is determined on line 89 (step 420) that Tr is not a subset of Tq, then the processing moves on to line 106 where a split brain condition is tested (line 108, not shown). The split brain situation occur when the cluster has been split into two disjoint subclusters that have no means of communicating with each other, therefore they form two independent clusters of the same identity. Step 360 then follows differently depending if the current topology Tq is a subset of the received topology Tr. If such is the case lines 113-115 are executed, which corresponds to set the list of nodes sharing the same view to {R}, update Vq to Vr, set sender_id and owner_id to R, update the Tq to Tr. If Tq is not a subset of Tr (i.e. merging back from split brain), then lines 118-121 are executed, which corresponds to reset the list of nodes sharing the same view, update Vq to the highest value between Vr and Vq, set sender_id and owner_id to my_id (i.e. Q), update the Tq to the union of Tq and Tr.

Thereafter, Q further verifies if Nmap corresponds to LN (list of neighboring nodes sharing the same view is equal to the list of neighboring nodes) (line 123). If so, it means that Q has only one neighboring node R to which it issues a JOIN message based on the current view (Vq, IDq, Tq) (line 126). If not so, Q forwards a JOIN message based on the current view (Vq, IDq, Tq) to all its neighboring nodes not sharing the same view (LN/Nmap) (129). It should be noted that the current view (Vq, IDq, Tq) used in the JOIN message of either line 126 or line 129 is affected by the line 113 or 119.

Line 131 concludes the case where the received topology Tr is not equal to the current topology Tq detected on line 84, step 410. Therefore the next table (Table 6: JOIN phase algorithm; part 4) shows the situation where Tr is equal to Tq starting on line 132, step 510.

TABLE 6
JOIN phase algorithm; part 4.

... Join phase (continued)

| | |
|---|---|
| 132 | else // Tq == Tr |
| 133 | begin |
| 134 | if Vr < Vq then |
| 135 | break // old message |
| 136 | if Vr == Vq then |
| 137 | if IDq < IDr then // remote ID is greater, accept it |
| 138 | begin |
| 139 | Nmap = {R} |
| 140 | (Vq, IDq, Tq) = (Vr, IDr, Tq) |
| 141 | Sender_ID = R |
| 142 | if Nmap == LN then |
| 143 | begin |
| 144 | conf = TRUE |
| 145 | send JOIN-VIEW to all in LN |
| 146 | end |
| 147 | else |
| 148 | begin |
| 149 | conf = FALSE |
| 150 | send JOIN-VIEW to all in LN \ Nmap |
| 151 | end |
| 152 | end |
| 153 | else |
| 154 | break |
| 155 | else // Vr > Vq, accept it |
| 156 | begin |
| 157 | Nmap = {R} |
| 158 | (Vq, IDq, Tq) = (Vr, IDr, Tq) |
| 159 | Sender_ID = R |
| 160 | if Nmap == LN then |
| 161 | begin |
| 162 | conf = TRUE |
| 163 | send JOIN-VIEW to all in LN |
| 164 | end |
| 165 | else |
| 166 | begin |
| 167 | conf = FALSE |
| 168 | send JOIN-VIEW to all in LN \ Nmap |
| 169 | end |
| 170 | end |
| 171 | end // different views |
| 172 | end // while loop |

Line 132 starts in the situation where Tr is equal to Tq starting, which is represented by step 410 on FIG. 7. The first verification performed on line 134, step 520 is whether the received vid Vr is less than the current vid Vq. If Vr is less than Vq, then the received JOIN message is discarded since it is old and the loop is broken (line 135, step 530). The next verification compares the current vid Vq with the received vid Vr. If they are equal, (line 136), the received owner_id IDr is compared to the current IDq.

If the current owner_id IDq is less than the received owner_id IDr (line 137, step 540), then the received JOIN message should be accepted (step 550). As mentioned previously, other conditions could apply as long as the condition is shared by all nodes implementing the cluster membership management protocol of the present invention. At this point step 550 is preformed wherein Nmap is reset to {R}, sender_id is put to R and the current view (Vq, IDq, Tr) is put in conformity with the received view (Vr, IDr, Tr). Step 550 is then performed differently if, on line 142, R is found to be the only neighboring node of Q (Nmap=LN). If such is the case, a JOIN message is sent thereto (line 145). If not, then a JOIN message is sent to all nodes in LN not in Nmap (neighboring nodes not sharing the same view, line 150). If the IDr is found to be greater (or equal, which should never happen) to IDq (line 153), then the loop is broken (line 154, step 530).

If, on line 136, the received vid Vr was found not equal to the current vid Vq, then, because of line 134, it means that Vr is greater than Vq (line 155, step 560). Step 550 is thus executed. More precisely, step 550 is preformed wherein Nmap is reset to {R}, sender_id is put to R and the current view (Vq, IDq, Tr) is put in conformity with the received view (Vr, IDr, Tr). Step 550 is then performed differently if, on line 160, R is found to be the only neighboring node of Q (Nmap=LN). If such is the case, a JOIN message is sent thereto (line 163). If not, then a JOIN message is sent to all nodes in LN not in Nmap (neighboring nodes not sharing the same view, line 168). This concludes the JOIN phase algorithm. Throughout tables 3-6, a conf variable is mentioned, but was not yet explained. This variable is used in an optimized version of the algorithm where acknowledging JOIN message (or confirmation JOIN) are sent only once by keeping track of when such a confirmation was sent using the conf variable.

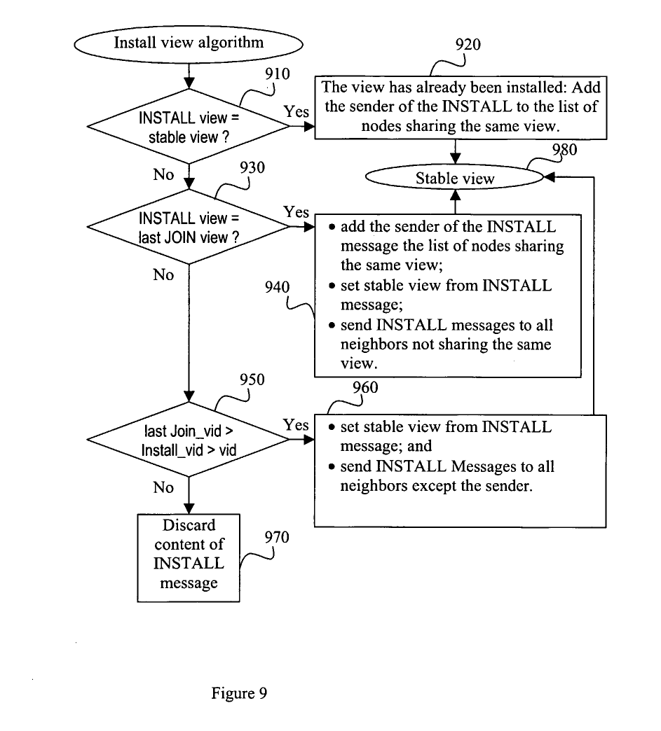

FIG. 9 is an exemplary flow chart of an INSTALL algorithm as defined by the cluster membership management protocol of the present invention.

TABLE 7
Install phase algorithm.

Install phase:

| | |
|---|---|
| 1 | while (INSTALL-VIEW received) do |
| 2 | begin |
| 3 | Receive a INSTALL-VIEW from a neighbor R with (Vr, IDr, Tr) |
| 4 | if (Vc, IDc, Tc) == (Vr, IDr, Tr) then // view has been installed already |
| 5 | begin |
| 6 | NmapI = NmapI U {R} |
| 7 | break |
| 8 | end |
| 9 | if (Vq, IDq, Tq) == (Vr, IDr, Tr) then // view is being installed |
| 10 | begin |
| 11 | NmapI = NmapI U {R} |
| 12 | (Vc, IDc, Tc) = (Vq, IDq, Tq) |
| 13 | send INSTALL-VIEW to all in LN \ Nmap |
| 14 | end |
| 15 | else |
| 16 | if Vq > Vr > Vc then // someone started an install that should go through |
| 17 | begin |
| 18 | (Vc, IDc, Tc) = (Vr, IDr, Tr) |
| 19 | send INSTALL-VIEW to all in LN \ {R} |
| 20 | end |
| 21 | else |
| 22 | break // drop anything |
| 23 | end // end install while loop |

The preceding table (Table 7: Install phase algorithm) matches with FIG. 9. Line 4 corresponds to step 910 where the view from the received INSTALL message (Vr, IDr, Tr) is compared to the last stable view (Vc, IDc, Tc). If they are found equal, R is added to a further list of neighboring nodes sharing the same view in the context of the Install phase algorithm (NmapI) and the INSTALL message is discarded since the view it contains is already installed (lines 6-7, step 920). NmapI is initialized (or reset) when the JOIN phase algorithm initiates or is ready for the INSTALL phase on either line 20 or 23 of Table 3 (not shown).

If step 910, line 4 determines that the views are different, then the received view (Vr, IDr, Tr) is compared to the current view (Vq, IDq, Tq) (line 9, step 930). If they are found equal, then the received view needs to be installed (step 940) by setting the stable view (Vc, IDc, Tc) to the received view (Vr, IDr, Tr), adding R to NmapI and forwarding the INSTALL message to all nodes on LN but not on NmapI (i.e. all neighboring nodes not sharing the same view).

If step 930, line 9 determines that the received view is different than the current view, then the view_ids are compared (line 16, step 950). If the current vid Vq is greater than the received vid Vr, which is in turn greater than the last known stable vid Vc, then the INSTALL message should be processed and forwarded to all neighboring nodes except R (lines 18-19, step 960), even though the view is already outdated. This prevents the situation where no view could be installed because of constantly changing membership information. All other received INSTALL messages are dropped (line 22, step 970). All cases other than step 970 finish on a stable view 980.

The following table (Table 8: Graceful termination algorithm) shows how a JOIN message (or LEAVE message) is sent in case of graceful termination of the algorithm in a node implementing the current cluster membership management protocol.

TABLE 8
Graceful termination algorithm.

| Graceful termination: | |
|---|---|
| 1 | (Vq, IDq, Tq) = (Vq + 1, 0, { }) // leaving the cluster hence |
| | { } and someone should take over the ownership hence 0 |
| 2 | send JOIN (Vq, IDq, Tq) to all neighbors |
| 3 | stop |

Basically, the current view of the leaving node is incremented, the owner_id is set to 0 or any other trigger value known to the other nodes of the cluster and the topology is set to empty set ({ }). A corresponding JOIN message is then sent to all neighboring nodes (LN).

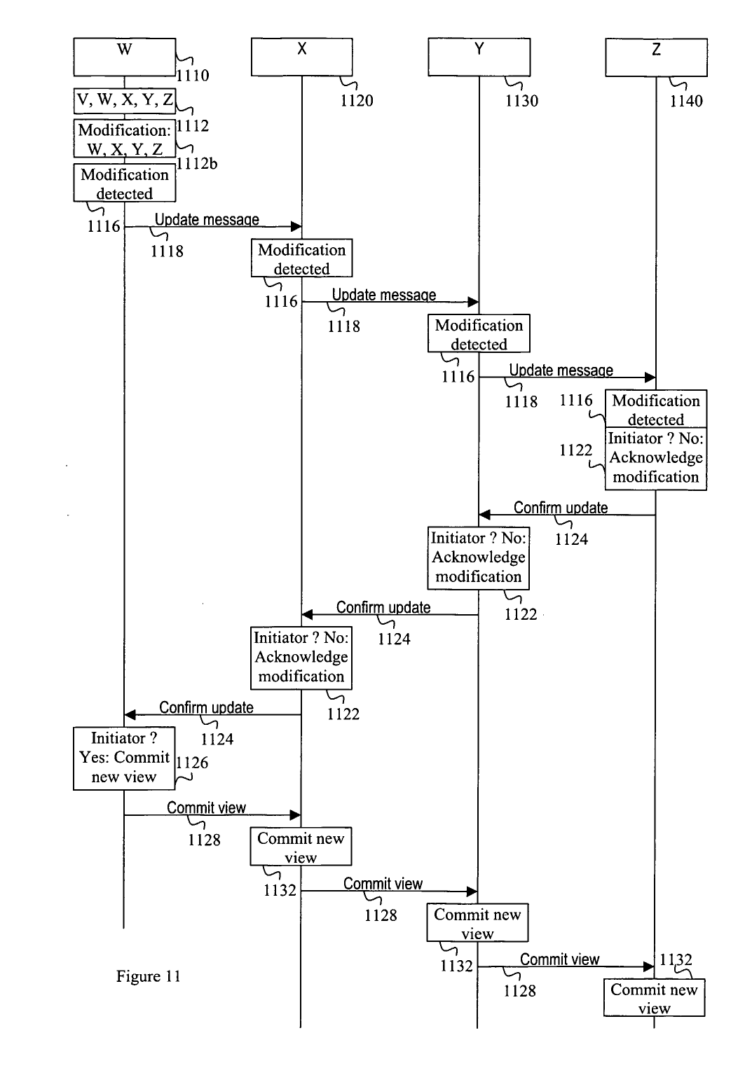

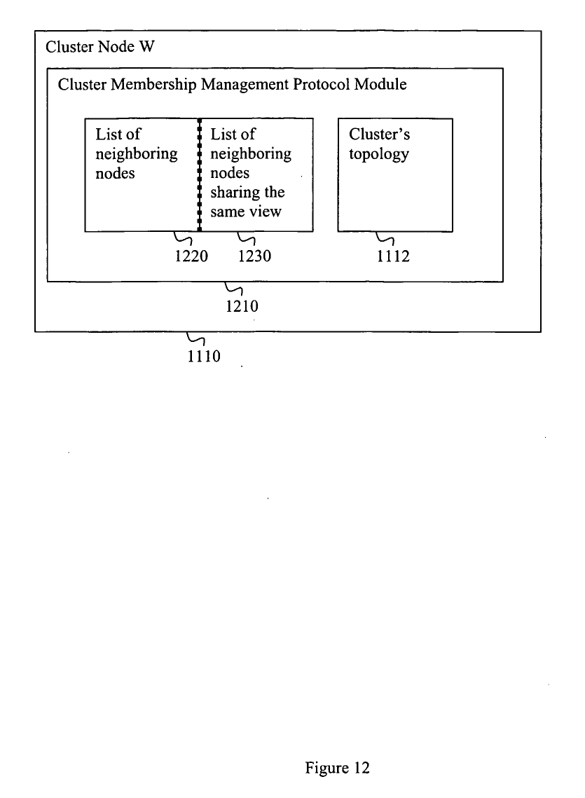

Reference is now made concurrently to FIG. 11 and FIG. 12, which respectively show an exemplary signal flow and nodal operation chart for the cluster membership management protocol and an exemplary modular representation of a cluster node in accordance therewith. FIG. 11 shows four cluster nodes W 1110, X 1120, Y 1130 and Z 1140 while FIG. 12 shows an exemplary architecture of W 1110. In the example shown, W 1110 has a single neighboring node X 1120 while X 1120 has W 1110 and Y 1130 as neighboring nodes and Z has Y 1130 as its sole neighboring node.

As a starting point, an exemplary topology 1112 is shown in W 1110. The topology 1112 represents a list of all member nodes of the cluster and is the simplest expression of a view in the present invention. The topology 1112 contains V (not shown) W 1110, X 1120, Y 1130 and Z 1140. W 1110, as the other cluster nodes X 1120, Y 1130 and Z 1140, maintains the topology 1112. The topology 1112 is likely to be maintained in W 1110 in a Cluster Membership Management Protocol Module 1210.

A modification to the topology 1112 then occurs, as shown by the new list 1112b on FIG. 12. Upon detection of the modification 1116, W 1110 begins updating the list in all member nodes of the cluster. This is achieved by sending an update message 1118 from W 1110 to its neighboring X 1120. The reception of the update message 1118 in X 1120 triggers the same detection of modification 1116 and, as a result, the same update message 1118 being sent. However, X 1120 sends the update message 1118 to its neighboring nodes except the source of the update message itself (i.e. X 1120 sends the update message 1116 to Y 1130). Y 1130 repeats exactly the same steps 1116 and 1118 toward Z 1140.

Since Z 1140, after step 1116, has no other neighboring node toward which to propagate the update, it checks if it is the initiator of the update message 1116 (step 1122). Since it is not, in the present example, Z 1140 acknowledges the detected modification 1116 by issuing a confirm update message 1124 toward the source from which it received the update message 1118. In the present case, Z 1140 sends the confirm message 1124 to Y 1130. Y performs step 1122 and forward the confirm update message 1124 to X 1120 since it is not the initiator of the update message 1118. X 1120 performs step 1122 as well and also forwards the confirm update message 1124 to W 1110 since it is not the initiator of the update message 1118.

Once W 1110 receives the confirm message 1110, it checks if it is the initiator of the update message 1118 (step 1126). Since it is the case and since all nodes to which the update message 1118 was sent replied to it, W 1110 sets a new stable view (still in step 1126) in accordance with the list 1112b and issues a commit view message 1128 to all neighboring nodes from which the confirm update message 1124 was received. In the present example, the commit view message 1128 is sent only to X 1120. Upon reception of the commit view message 1128, X 1120 sets the new stable view (step 1132) in accordance therewith and forwards the commit view message 1128 toward its neighboring nodes, except the source (i.e. Y 1130). Y 1130 and Z 1140 repeat the same operations.

As an option to the previous description, the confirm update message 1124 could be a simple copy of the received update message 1118, which is sent back to its source. Other types of confirmation could be used as well.

Alternatively, W 1110 may maintain a first list of neighboring nodes 1220 and a second list of neighboring nodes sharing the current view 1230. Therefore, the message exchange between the four nodes W 1110, X 1120, Y 1130 and Z 1140 aims at ensuring that the first list matches the second list. A plurality of messages 1118 and 1124 is therefore exchanged between W 1120 and the nodes listed on the first list of neighboring nodes (namely X 1120 in the present example). Each of the plurality of the messages 1118 and 1124 should comprise the topology information related to the cluster's membership. The nodes are added from the first list to the second list when the modification is updated 1112b and no update message 1118 needs to be sent to further neighboring nods. Once the first list matches the second list, a confirmation message is sent. The confirmation message, in this case, can be seen as either the confirm update message 1124 or the commit view message 1128, with the differences that extra conditions for sending the commit view message 1128 are to be the initiator of the update message 1118 and not having anymore confirm update message 1124 to send.

Between the moment where a node sends the confirm update message 1124 and the moment it receives the commit view message 1128, the view is not seen as stable, but is the most updated view that the node has. The step 1132 of setting the stable view from the commit view message 1128 may further comprise verifying that the new view is up to date in comparison to the most updated view that the node has. If the new view is not up to date (e.g. further modifications detected), the confirmation message is discarded and if the new view is up to date, the commit view message is applied.

It should be readily understood the two lists mentioned for maintaining the neighboring nodes and the neighboring nodes sharing the same view could be, in some implementations, a single list where the attribute “sharing the same view” is added to the first list.

Although several preferred embodiments of the present invention have been illustrated in the accompanying drawings and described in the foregoing description, it will be understood that the invention is not limited to the embodiments disclosed, but is capable of numerous rearrangements, modifications and substitutions without departing from the teachings of the present invention. For example, even though the figures present simple and linear cluster topologies to facilitate understanding, this is not to be construed as a pre-requisite of the cluster membership management protocol of the present invention. Indeed, the solution applies to clusters of arbitrary topology and is also fitted to large topology. In general, statements made in the description of the present invention do not necessarily limit any of the various claimed aspects of the present invention. Moreover, some statements may apply to some inventive features but not to others. In the drawings, like or similar elements are designated with identical reference numerals throughout the several views, and the various elements depicted are not necessarily drawn to scale.

1. A method for maintaining a current view of a cluster's membership in a network comprising a plurality of nodes, the method comprising the steps of:
maintaining a list of member nodes of the cluster; and
updating the list in member nodes of the cluster when a modification thereto is noticed by a first node by:
receiving a first update message from the first node in a second node of the network, wherein the second node is a neighboring node of the first node;
thereafter, sending a second update message from the second node to at least a third node of the network to propagate the modification, wherein the third node is a neighboring node of the second node; and
sending to the first node a first confirm message from one of the second or the third node confirming the modification.

2. The method of claim 1 further comprising, before sending to the first node the first confirm message, a step of:
receiving by the second node a second confirm message from the third node confirming the modification;
wherein the step of sending to the first node the first confirm message is performed from the second node.

3. The method of claim 1 wherein the step of sending the first confirm message is performed by resending the first update message back to the first node to confirm the modification.

4. The method of claim 1 wherein the step of updating the list when a modification thereto is noticed is performed upon reception by the first node of a third update message containing the modification wherein the third update message is received from a fourth node before the step of receiving the first update message in the second node and wherein the fourth node is a neighboring node of the first node, the method further comprising a step of sending a third confirm message from the first node to the fourth node upon reception of the first confirm message.

5. The method of claim 1 wherein the step of sending the second update message from the second node is performed by sending the second update message to all neighboring nodes of the second node except the first node, the first node being the source of the first update message and wherein the step of sending the first confirm message is performed from the second node upon reception of a further confirm message from each of the neighboring nodes to which the second update message was sent.

6. The method of claim 1 further comprising a step of sending the first update message from the first node to all its neighboring nodes, wherein the method further comprises following the step of sending the first confirm message performed from the second node, the steps of:
receiving the first confirm message in the first node;
determining if a confirm message is received for each sent first update message; and
if so:
marking the current view as a stable view; and
sending a commit view message to all neighboring nodes from
which the confirm messages were received.

7. The method of claim 6 wherein the step of determining further comprises determining if the first node is an initiator of the first update message.

8. A node member of a cluster in a network, the node comprising:
a cluster membership management protocol module capable of:
maintaining a first list of neighboring nodes;
maintaining a second list of neighboring nodes sharing a current view of the cluster's membership therewith;
ensuring that the first list matches the second list by exchanging a plurality of messages with at least one node in the first list of neighboring nodes, wherein each of the plurality of the messages comprises topology information on the cluster's membership; and
upon confirmation that the first list matches the second list, sending a confirmation message to at least one neighboring node listed on either equivalent lists.

9. The node of claim 8 wherein the cluster membership management module is further capable of:
receiving a commit view message from a first node on the first list of neighboring nodes;
setting the current view as a stable view; and
forwarding the commit view message to at least a second node in the first list of neighboring nodes

10. The node of claim 9 wherein the cluster membership management module is further capable of forwarding the commit view message if the second node is not on a third list of neighboring nodes sharing the stable view.

11. The node of claim 8 wherein the cluster membership management module is further capable of:
determining if the node is an initiator of the first message from the plurality of messages; and
if so:
marking the current view as a stable view; and
sending the confirmation message to commit the current view as a stable view message toward the at least one neighboring node listed on either equivalent lists.
